(19) United States
(12) Patent Application Publication
(10) Pub. No.: US 2013/0321161 A1
(43) Pub. Date: Dec. 5, 2013

(54) CLOUD-BASED FIRE ALARM CONTROL SYSTEM

(71) Applicant: HON HAI PRECISION INDUSTRY CO., LTD., New Taipei (TW)

(72) Inventor: CHIEN-LIN CHEN, New Taipei (TW)

(73) Assignee: HON HAI PRECISION INDUSTRY CO., LTD., New Taipei (TW)

(21) Appl. No.: 13/747,600

(22) Filed: Jan. 23, 2013

(30) Foreign Application Priority Data
May 31, 2012 (TW) 101119497

(51) Int. Cl. G08B 17/00

(52) U.S. Cl. CPC G08B 17/00
USPC 340/628

(57) ABSTRACT

The present disclosure provides a cloud-based fire alarm control system including an electronic device, a plurality of fire sensors, a plurality of fire control devices, and at least one cloud-based loop control units. The cloud-based loop control units are connected to the fire sensors and the fire control devices, and are further connected to the electronic device through a network. The electronic device includes a display screen and a control software, the control software is operable to obtain fire alarm information and fire control monitoring information when a fire alarm is detected in a specified monitored area, and display the fire alarm information and the fire control monitoring information on the display screen.

### BACKGROUND

1. Technical Field

Embodiments of the present disclosure relate to safety monitoring technology, and particularly to cloud-based fire alarm control system.

2. Description of Related Art

R-Type fire alarm control panels (R-FACP) are widely used in safety monitoring system, referring to FIG. 1, an R-FACP 1000 is connected to a plurality of fire sensors 4 and fire control devices (e.g., smoke exhaust devices) 5. The R-FACP 1000 may include, but is not limited to, a loop control unit, a display screen, and a control software, the control software can perform functions of a fire alarm system, a fire control monitoring system, and a mechanical and electrical system. Further referring to FIG. 2, the R-FACP 1000 provides a user interface having a main menu, the main menu includes a plurality of function buttons. A user may select specified function buttons to browse fire alarms, set system time, and print history alarm messages.

However, each monitored area must be contain one fire alarm control panel, it is expensive when large areas need to be monitored, and it is difficult to manage the number of fire alarm control panels when the monitored areas are widely dispersed. Therefore, an efficient method for monitoring fire alarm is desired.

### BRIEF DESCRIPTION OF THE DRAWINGS

FIG. 1 is a schematic diagram of an example of an R-Type fire alarm control panel connected to fire sensors and fire control devices in the prior art.

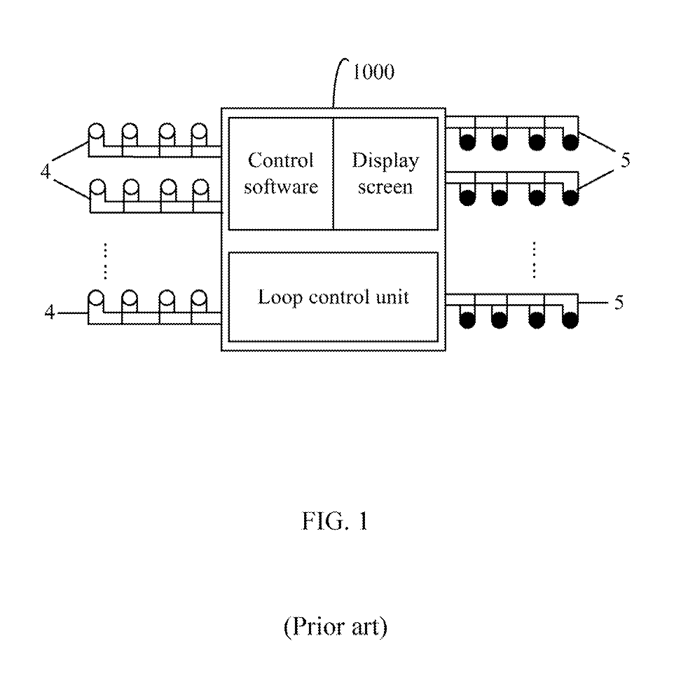

FIG. 2 is a schematic diagram of an example of a user interface of the R-Type fire alarm control panel in FIG. 1.

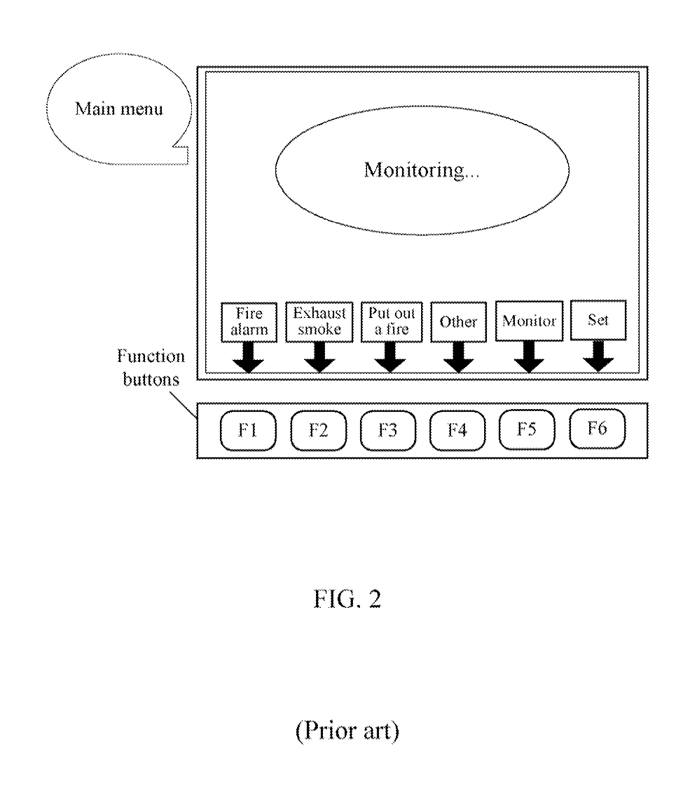

FIG. 3 is a schematic diagram of a first embodiment of a cloud-based fire alarm control system.

FIG. 4 is a schematic diagram of one embodiment of an electronic device of FIG. 3.

FIG. 5 is a schematic diagram of one embodiment of a control software including a fire control monitoring system and a fire alarm system.

FIG. 6 is a schematic diagram of a second embodiment of the cloud-based fire alarm control system.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

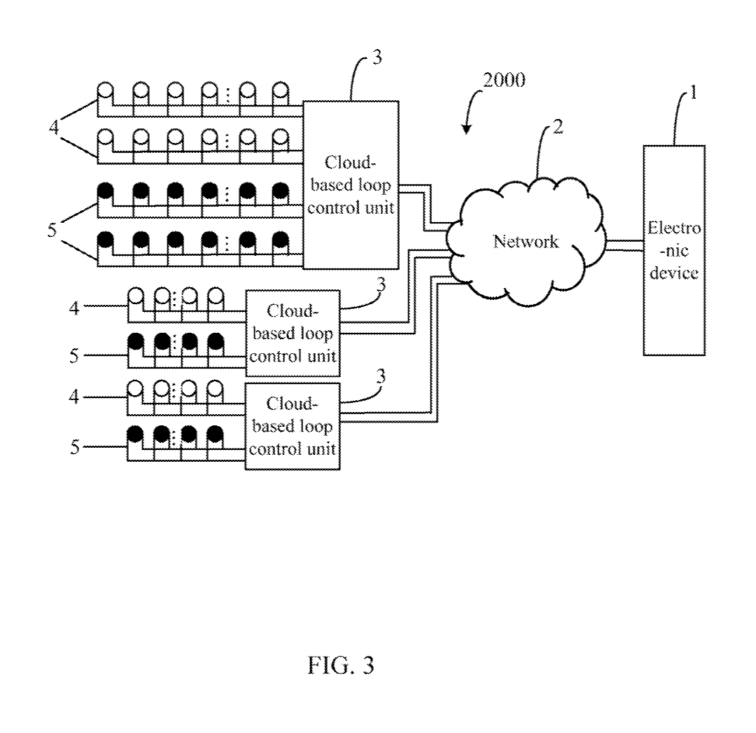

FIG. 3 is a schematic diagram of a first embodiment of a cloud-based fire alarm control system 2000. The cloud-based fire alarm control system 2000 may include, but is not limited to, at least one cloud-based loop control unit 3, a plurality of fire sensors 4 and fire control devices (e.g., smoke exhaust devices) 5 which are installed in monitored areas. In some embodiments, the cloud-based loop control unit 3 is a loop control unit that connects to a cloud computing center (e.g., an electronic device 1) through a network 2. The electronic device 1 obtains fire alarm information and fire control monitoring information of the monitored areas from the cloud-based loop control unit 3 through the network 2. For example, a building may include a plurality of monitored areas, each monitored area is equipped with one or more fire sensors 4 and fire control devices 5, the fire alarm information and the fire control monitoring information of a specified monitored area in the building are obtained by the cloud-based loop control unit 3, and sent to the electronic device 1 through the network 2.

In the first embodiment, the network 2 may be a transmission control protocol/Internet protocol (TCP/IP) network. The fire sensor 4 is used to detect whether a fire alarm is activated in the specified monitored area, and capture an image of the specified monitored area when the fire alarm is detected. The fire control devices 5 may include smoke exhaust fans, alarm bells, smoke dampers, watering devices, and escape routes.

In this first embodiment, the cloud-based loop control unit 3 has one or more microprocessor chips of a fire alarm control panel 1000. The fire alarm control panel 1000 may be an R-Type fire alarm control panel (R-FACP) or a P-Type fire alarm control panel (P-FACP).

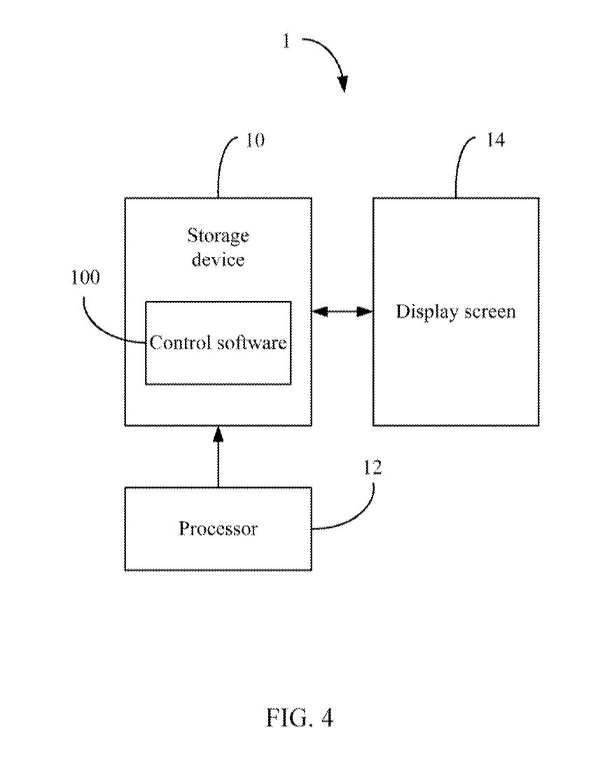

FIG. 4 is a schematic diagram of one embodiment of the electronic device 1 of FIG. 3. The electronic device 1 includes a storage device 10, at least one processor 12, and a display screen 14, the electronic device 1 may be a computer or other suitable data processing equipment.

The storage device 10 is used to store fire alarm information detected by the fire sensors 4, and store fire control monitoring information of the fire control devices 5, and monitoring parameters (e.g., monitoring time interval) set by a user of the electronic device 1. The fire control monitoring information may include states of the fire control devices 5, for example, the states that represent whether the water pipe has water, whether the alarm bell is disabled, whether a power supply of the smoke exhaust fan is normal, or whether the watering device and the escape routes are normal, etc.

In one embodiment, the storage device 10 further stores computerized program codes of a control software 100, the storage device 10 may be an inner storage of the electronic device 1, or an external storage of the electronic device 1.

The processor 12 executes the computerized program codes of the control software 100, so as to detect whether a fire alarm is activated in each monitored area, obtain the fire alarm information and the fire control monitoring information when the fire alarm is detected, and detect states (e.g., normal or abnormal) of the fire control devices 5.

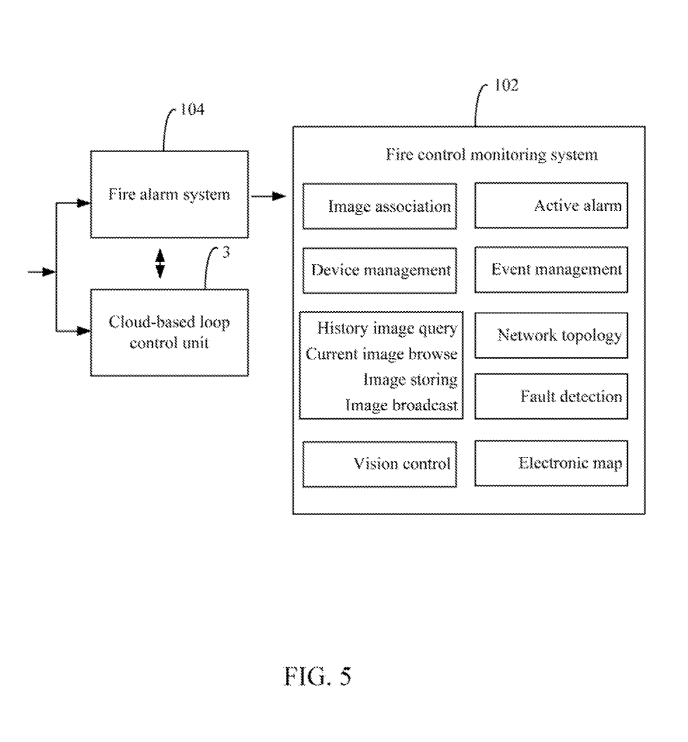

The display screen 14 provides a user interface to display the fire alarm information and the fire control monitoring information using specified modes (e.g., indicator light), and display an image of a specified monitored area where the fire alarm is detected. For example, the fire alarm information may include a location of the specified monitored area, a detection time of the fire alarm. The user may further query history record of the fire alarm information and the fire control monitoring information using the user interface (refers to FIG. 5).

In the first embodiment, the cloud-based loop control unit 3 obtains the fire alarm information detected by the fire sensors 4 using a first microprocessor chip (e.g., dsPIC30F4011 microchip), detects whether the fire control devices (e.g., the alarm bell) is normal using a second microprocessor chip (e.g., W78E52 microchip), displays the fire alarm information and the fire control monitoring information on the display screen 14 using a third microprocessor chip (e.g., W77E58), sets the system time and print parameters. The control software 100 may be programmed using a visual programming tool, and outputs alarm information when the electronic device 1 is broken down.

In other embodiments, one or more repeaters may be installed between the cloud-based loop control units 3 and the fire sensors 4, so as to retransmit signals between the cloud-based loop control units 3 and the fire sensors 4. One or more repeaters may be installed between the cloud-based loop control units 3 and the fire control devices 5, so as to retransmit signals between the cloud-based loop control units 3 and the fire control devices 5.

FIG. 5 is a schematic diagram of one embodiment of the control software 100 including a fire control monitoring system 102 and a fire alarm system 104. The fire control monitoring system 102 includes the functions of image association, device management, image management, active alarm, event management, network topology, fault detection, for example. An electronic map of the monitored areas is stored in the fire control monitoring system 102. The function of image association is used to associate a specified monitored area with a corresponding image captured by the fire sensor 4, so that the user can easily find out the specified monitored area of the fire alarm. The device management is used to associate all fire control devices 5 in the specified monitored area. The active alarm is used to send the fire alarm information to the electronic device 1 through a short message or an E-mail when the fire alarm is detected in the specified monitored area.

The fire alarm system 104 is used to output alarm signals when the fire alarm is detected in the specified monitored area, the alarm signals may be an audio alarm, or a visual alarm such as turning on and off the display screen 14 or a message on the display screen 14 of the electronic device 1.

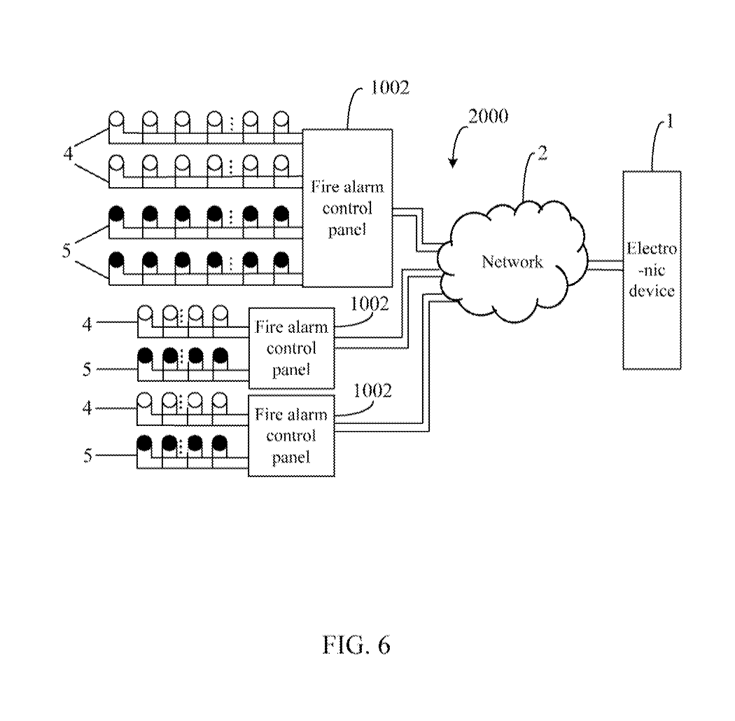

FIG. 6 is a schematic diagram of a second embodiment of the cloud-based fire alarm control system 2000. In the second embodiment, the cloud-based fire alarm control system 2000 may include, but is not limited to, at least one simplified fire alarm control panels 1002, a plurality of fire sensors 4 and fire control devices (e.g., smoke exhaust devices) 5 which are installed in monitored areas. The simplified fire alarm control panels 1002 are connected to the electronic device 1 through the network 2. The electronic device 1 includes the display screen 14 and the control software 100, the control software 100 includes the fire control monitoring system 102 and the fire alarm system 104.

In the second embodiment, the simplified fire alarm control panel 1002 includes the cloud-based loop control unit 3 and a display screen. The simplified fire alarm control panel 1002 may be a simplified R-Type fire alarm control panel (R-FACP) or a simplified P-Type fire alarm control panel (P-FACP).

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A cloud-based fire alarm control system, comprising:
an electronic device;
a plurality of fire sensors;
a plurality of fire control devices; and
at least one cloud-based loop control units;
wherein the at least one cloud-based loop control units are connected to the fire sensors and the fire control devices, and are connected to the electronic device through a network; and
the electronic device comprises a display screen, and a control software that obtains fire alarm information and fire control monitoring information when a fire alarm is detected in a specified monitored area, and displays the fire alarm information and the fire control monitoring information on the display screen.

2. The cloud-based fire alarm control system according to claim 1, wherein the fire control devices comprise smoke exhaust fans, alarm bells, smoke dampers, watering devices, and escape routes.

3. The cloud-based fire alarm control system according to claim 1, wherein the control software comprises a fire alarm system that obtains the fire alarm information, and a fire control monitoring system that obtains the fire control monitoring information.

4. The cloud-based fire alarm control system according to claim 1, wherein the fire alarm information comprise a location of the specified monitored area, a detection time of the fire alarm, and the fire control monitoring information comprise states of the fire control devices.

5. The cloud-based fire alarm control system according to claim 1, wherein the cloud-based loop control units are microprocessor chips of fire alarm control panels.

6. The cloud-based fire alarm control system according to claim 5, wherein the fire alarm control panel is an R-Type fire alarm control panel or a P-Type fire alarm control panel.

7. A cloud-based fire alarm control system, comprising:
an electronic device;
a plurality of fire sensors;
a plurality of fire control devices; and
at least one fire alarm control panels;
wherein the at least one fire alarm control panels are connected to the fire sensors and the fire control devices, and are connected to the electronic device through a network; and
the electronic device comprises a first display screen, and a control software that obtains fire alarm information and fire control monitoring information when a fire alarm is detected in a specified monitored area, and displays the fire alarm information and the fire control monitoring information on the first display screen.

8. The cloud-based fire alarm control system according to claim 7, wherein the fire control devices comprise smoke exhaust fans, alarm bells, smoke dampers, watering devices, and escape routes.

9. The cloud-based fire alarm control system according to claim 7, wherein the control software comprises a fire alarm system that obtains the fire alarm information, and a fire control monitoring system that obtains the fire control monitoring information.

10. The cloud-based fire alarm control system according to claim 7, wherein the fire alarm information comprise a location of the specified monitored area, a detection time of the fire alarm, and the fire control monitoring information comprise states of the fire control devices.

11. The cloud-based fire alarm control system according to claim 7, wherein the fire alarm control panel comprises a cloud-based loop control unit and a second display screen.

12. The cloud-based fire alarm control system according to claim 11, wherein the fire alarm control panel is an R-Type fire alarm control panel or a P-Type fire alarm control panel.
